(19) United States
(12) Patent Application Publication
(10) Pub. No.: US 2026/0297418 A1
(43) Pub. Date: Oct. 1, 2026

(54) PROVIDING SELECTIVE DISSOLVABLE COATINGS ON A MULTI-SHELL CORE SYSTEM FOR INFLOW CONTROL DEVICES

(71) Applicant: Saudi Arabian Oil Company, Dhahran (SA)

(72) Inventors: Pranay Asthana, Dhahran (SA); Nourah AlMusharraf, Dhahran (SA); Edreese Alsharaeh, Riyadh (SA); Haneen Omar, Riyadh (SA); Suresh Jacob, Dhahran (SA); Ahmed A. Al Sulaiman, Dammam (SA); Ahmed Y. Bukhamseen, Dammam (SA)

(21) Appl. No.: 19/089,725

(22) Filed: Mar. 25, 2025

(51) Int. Cl. C09K 8/516; E21B 41/02

(52) U.S. Cl. CPC C09K 8/516; E21B 41/02; C09K 2208/10

(57) ABSTRACT

A multi-shell core composite includes a core which is surrounded by multiple layers of coated materials. The multi-shell core composite can provide oil- and water-selective dissolvable coatings for application in a chemical autonomous inflow control device (AICD). Each layer of the multi-shell core composite is prepared such that it selectively dissolves in contact with a hydrophobic or aqueous fluid. Each layer includes metal oxide nanoparticles. The first layer or the innermost layer includes a mixture of a binder and metal oxide nanoparticle. As each layer dissolves, the overall diameter of the core composite reduces, facilitating its movement through the AICD.

### TECHNICAL FIELD

This disclosure relates to methods of synthesizing a multi-shell core (MSC) composites for inflow control devices (ICDs).

### BACKGROUND

Surface coating techniques can be used to form core-shell systems. By creating multiple shells using various materials, the properties and functions of the system can be altered. During oil production, premature water breakthrough from reservoirs can be a major challenge. ICDs are flow control devices which are placed in specific segmented intervals, also known as compartments, along a production well's horizontal section to control the premature water production.

### SUMMARY

This specification describes a MSC composite for use in inflow control devices (ICDs) and methods for preparing the MSC composites. The MSC composite includes a core coated with layers of different materials. The layers are selected to be dissolvable in oil or aqueous fluids for use in chemical autonomous inflow control device (AICD) applications. For example, a ball mill can be used to uniformly deposit multiple layers of metal oxide nanoparticles (e.g., silicon dioxide (SiO₂), titanium oxide (TiO₂), and iron oxide (Fe₂O₃)) on a ball-shaped core to provide a desired sequence of dissolution of these layers.

The MSC composite can provide reliable and superior performance as a chemical AICD as its wettability changes in response to an external stimuli, such as contact with hydrophobic or aqueous fluids under reservoir conditions. The change in wettability can be achieved by the dissolution of the multiple layers, where one layer is dissolved to expose the subsequent layer beneath it. The composition and thickness of the layers can align the dissolution with a production well's lifecycle, which includes a cleanup of brine after drilling is performed, followed by oil production, water breakthrough, and the ingress of water in increasing proportions. The core is not dissolvable and can be used to shut off unwanted water production through the ICD. The MSC composite can be produced effectively using scalable techniques.

The MSC composite can also be used for selective injection and stimulation in a production well's late lifecycle and for flowback operations in the early lifecycle. The MSC composite can perform effectively in isolating sections of a well, preventing water influx and maintaining well integrity over time. The MSC composite is durable and has long-term reliability. This can reduce downtime by limiting interventions and maintenance requirements. The core composite can be customized to meet varying well conditions, such as different pressures, temperatures, and fluid compositions, making it a flexible solution for diverse operational challenges.

### BRIEF DESCRIPTION OF DRAWINGS

FIG. 1A is a schematic representation of an ICD with a MSC composite.

FIG. 1B is a schematic representation of the MSC composite.

FIG. 2 is a schematic representation of a preparation process of the MSC composite using a ball mill.

FIG. 3 shows X-ray diffraction (XRD) patterns for a MSC composite.

FIG. 4 shows XRD patterns for a MSC composite.

FIG. 5 shows XRD patterns for a MSC composite.

FIG. 6 is a plot presenting experimental dissolution results of a multi-shell aluminum core ball.

FIG. 7 is a plot presenting experimental dissolution results of a multi-shell aluminum core ball.

FIG. 8 is a plot presenting experimental dissolution results of a multi-shell aluminum core ball.

FIG. 9 shows contact angles of coated flat substrates.

FIG. 10 is a process flow diagram representing the formation of the MSC composite.

### DETAILED DESCRIPTION

This specification describes a MSC composite for ICDs and methods for preparing the MSC composite. The MSC composite includes a core which is surrounded by multiple layers of materials. The MSC composite can provide oil- and water-selective dissolvable coatings for application in a chemical AICD application. Each layer of the MSC composite is prepared such that it selectively dissolves in contact with a hydrophobic or aqueous fluid. A ball mill can be used to uniformly deposit multiple layers on a core.

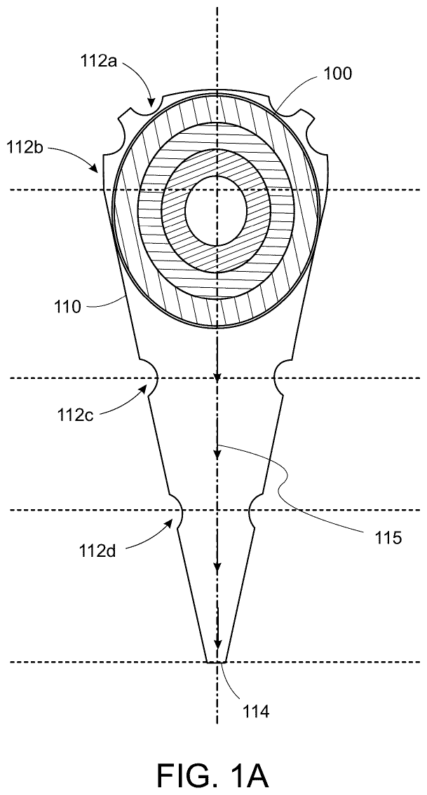

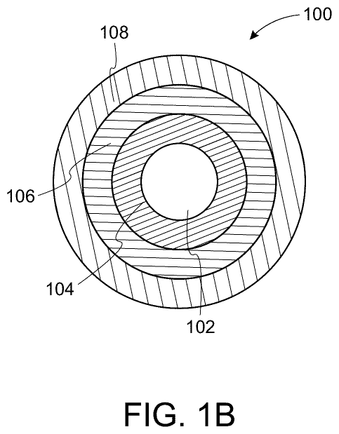

FIG. 1A is a schematic representation of an MSC composite 100 placed in the top section of the ICD 110. FIG. 1B is a schematic representation of the MSC composite 100.

The MSC composites include a core coated by two or more layers. The selection of the number of layers depends on factors, such as the operational sequences in a new well. The illustrated MSC composite 100 includes a core coated with a inner layer (i.e., first layer 104), an intermediate layer (i.e., second layer 106), and an outer layer (i.e., third layer 108). The layers are made of different materials.

The ICD 110 is a funnel shaped device which includes multiple inflow ports 112a-d and an outflow port 114. Reservoir fluids flow into the ICD 110 through the inflow ports 112a-d.

The multiple layers of the MSC composite dissolve when in contact with the reservoir fluids (e.g., oil for hydrophobic layers or water for aqueous layers). As the layers dissolve, the MSC composite 100 gets smaller and moves farther into the ICD 110 to a narrower section of the funnel. Arrows 115 show the direction of movement through the ICD 110 towards the outflow port 114. The diameter of the outflow port 114 is smaller than the diameter of the core so the core shuts off fluid flow through the outflow end after the innermost layer is dissolved.

The size of the core is selected such that it has a diameter larger than the diameter of the outflow port of the ICD (see 114 in FIG. 1A). The core 102 has a diameter of 3 mm. In some implementations, the core 102 includes materials such as metallic or non-metallic ceramic, teflon, stainless steel, aluminum, glass, 13 chromium steel, alloy steel, or tungsten carbide. The materials are selected such that the core 102 does not dissolve when in contact with hydrophobic and aqueous fluids, such as crude oil and water, respectively. In addition, the core 102 possesses mechanical strength to withstand high pressures and forces encountered in the wellbore. It is durable, tolerant of high temperatures, and corrosion resistant, maintaining its structural integrity under all wellbore conditions. The material for the core 102 is selected such that the density and weight of the core 102 facilitates its proper functioning in its intended position in the well. Materials like stainless steel and alloy steel offer reliable and cost-effective solutions, while higher-performance materials like tungsten carbide is chosen for more demanding applications.

The first layer 104 of inorganic metal oxide nanoparticles is uniformly coated on the surface of the core 102. In some implementations, a binder is mixed with the inorganic metal oxide nanoparticles for the first layer 104 of coating. In some implementations, the binder is deposited on the surface of the core 102 before depositing the first layer 104. The binder helps to create an adhesion between the inorganic metal oxide nanoparticles of first layer 104 and the core 102. The first layer 104 selectively dissolves upon contact with a aqueous fluid, such as water produced from an oil-bearing reservoir. The chemical composition of the first layer 104 is selected based on solubility in aqueous fluids (e.g., brine or sea water). Upon contact with aqueous fluids, the inorganic nanoparticles of the first layer 104 undergo hydrolysis or dissolution reactions, causing the material to break down gradually. In some implementations, this interaction involves water molecules breaking down the metal-oxygen bonds or dissolving the metal oxide particles.

The second layer 106 of inorganic metal oxide nanoparticles is uniformly coated on top of the first layer 104. The composition of the second layer 106 differs from that of the first layer 104 in this example. The second layer typically does not include a binder is not mixed with the metal oxide nanoparticles. The dissolution of the second layer 106 is driven by hydrolysis or ion exchange reactions. The second layer 106 selectively dissolves upon contact with a aqueous fluid (e.g., sea water, brine, or water). The time for dissolution of the second layer 106 also depends on factors such as volume of water (water cut %) in contact with the second layer 106, ionic composition of the water, temperature, and pH of the water.

The third layer 108 is a hydrophobic layer that includes inorganic metal oxide nanoparticles is uniformly coated on top of the second layer 106. The composition of the third layer 108 differs from that of the first and second layers in this example. The third layer 108 does not include a binder with the metal oxide nanoparticles. This layer dissolves when in contact with a hydrophobic fluid, such as oil. Oil can penetrate and interact with the inorganic nanoparticles on the third layer 108, breaking down the structural bonds more easily than water. In some implementations, the metal oxide nanoparticles are solubilized in the oil.

The compositions and thicknesses of the layers are chosen so movement of the MSC composite in the ICD matches the change of production fluids through the life of a well. A new well has a lifecycle that begins with a cleanup of brine after drilling, followed by oil production. As oil is depleted, water breakthrough occurs and water is an increasing proportion of fluids produced. The combination of layers allows the coatings to dissolve in a sequence aligned with the operational time of a newly drilled well that is planned for ICD completion. The layers cause the MSC composite 100 to switch its wetting properties in response to changes in the environmental conditions (contact with hydrophobic or aqueous fluids), with each layer dissolving and exposing the subsequent layer beneath it. Each layer reacts differently with the reservoir fluids, depending on its composition. Laboratory experiments using fluids produced from a specific reservoir can be used to determine the dissolution time of layers of specific thicknesses and compositions.

In use, oil contacts the third layer 108 when oil production begins after the cleanup stage. When this layer is in contact with oil, the reaction of the elements of the third layer 108 with oil causes a breakdown of the layer through dissolution and reduces the overall diameter of the MSC composite. Typically, the dissolution time is about 5-7 days after which the MSC composite 100 moves to the next position in the ICD device, without changing the flow area or number of open flow ports. The oil production continues even after the dissolution of the third layer 108. The dissolution rate of the third layer 108 can depend on the oil type such as light or heavy oil, viscosity of the oil, oil composition (presence of asphaltenes, resins, or polar compounds), reservoir temperature, pressure, oil saturation, and fluid flow dynamics. In some implementations, high temperatures can accelerate reaction kinetics, leading to a faster breakdown of the inorganic metal oxide nanoparticles upon contact with oil. The rapid dissolution of this layer facilitates the movement of the MSC composite 100 through the ICD so that the subsequent layers would dissolve and the core 102 shuts off excess water flow through the ICD. The time for oil production is monitored at the surface to determine the time for dissolution of this layer.

After the third layer 108 dissolves, the second layer 106 is exposed to the reservoir fluids. As the reservoir fluids are produced, water breakthrough occurs. This results in the production of both oil and water together. For example, water can account for about 30-70% of the fluid volume produced during this phase. The second layer 106 is a hydrophilic layer. When the second layer 106 is in contact with water, it dissolves in a period of 90-100 days. After the second layer 106 dissolves, the first layer 104 is exposed.

As the production of reservoir fluids continues, the well produces a higher proportion of water, which in this case is greater than 70% of the total fluid volume produced. The first layer 104 gradually dissolves when in contact with produced fluids having a higher concentrations of water. This exposes the core 102 beneath it. The diameter of the MSC composite ball reduces and the linear position of the MSC composite ball moves through the ICD, where it lands in a position above the outflow end of the ICD. The outflow end of the ICD is connected to the production tubing string through which the reservoir fluids flow to the surface for further processing. The diameter of the outflow end of the ICD is lesser than the diameter of the core 102. This results in choking any further water flow through the ICD outflow port into the production tubing string. The core 102 is not dissolvable.

The dissolution rate of each layer can also vary depending on the reservoir conditions, such as temperature, pressure, and salinity. The temperature in a reservoir can range between 170-220° F. (76-105° C.). The pressure can range between 2000-4000 psi (13.7-27.6 MPa). The salinity can range between 40,000-200,000 total dissolved solids (TDS).

The thickness of each layer is precisely controlled to 1 mm (i.e., diameter of each layer will increase the overall composite diameter by 2 mm). The layers of 1 mm thickness each will form an overall diameter of 9 mm for a 3 layered MSC composite 100. This is the size needed in this example to design an AICD device to choke water flow after the well experiences a high water production. The thickness of each coated layer can vary based on the specific application, such as the dimensions and flow area of the ICD.

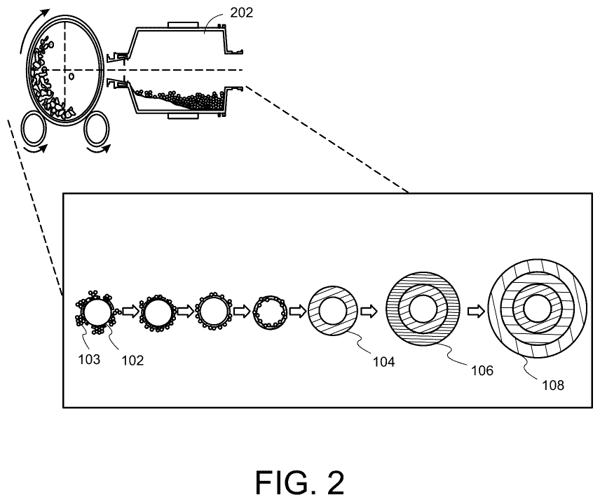

FIG. 2 is a schematic representation of a preparation process of the MSC composite using a ball mill. A ball mill machine 202 was used to deposit the layers on the core 102. In this example, the core 102 was made up of aluminum. In some cases, Teflon (PTFE) was used as the material for the core 102. The diameter of the core 102 was chosen to be 3 mm in this example. The parameters of the ball mill machine 202 were selected by using a design of experiments to create the right energy and mechanical compaction forces to allow for the layers to build up to a thickness of 1 mm each. These experiments identified the appropriate materials to provide the properties of the various layers.

The ball mill machine 202 created thin and uniform layers with consistent and homogeneous material deposition on the core 102. The parameters of the ball mill machine 202 included but not limited to time, temperature, powder size, and mix ratio. A binder 103 was deposited on the core 102 to facilitate a strong interfacial adhesion between the core 102 and the metal oxide nanoparticles, promoting a uniform coating. The build-up rate in the ball mill depends on the revolution per minute used and the time of operation. The binder 103 creates robust adhesion and increases the stability and durability of the coating, as it provides even dispersion of the metal oxide nanoparticles during the ball milling process, preventing agglomeration. Additionally, the flexibility and toughness of the binder 103 allows it to withstand the mechanical stresses encountered during milling, preventing cracking or delamination of the coating, and enhancing the overall mechanical integrity of the coated material.

For this application, a vibratory SPEX Mixer/Mill 8000 ball mill machine was used. The ball mill machine included stainless steel chambers. The deposition of inorganic metal oxide particles on the aluminum/PTFE balls was tested both in isolation and in combination with APTES and PVDC binder. Each milling session was carried out over a duration of 5 minutes, using 15 aluminum/PTFE balls, each measuring 3 mm in diameter. A precise amount of 100 mg of inorganic metal oxide powder was used at a weight ratio of 1:1.5 in relation to the milling balls. In experiments that included the binder, one drop of APTES or 11 mg of PVDC was initially added and milled for 5 minutes, after which the inorganic metal oxide powder was introduced and milled for an additional 5 minutes.

The core 102 was coated with three layers, each with a specific composition to form either a aqueous or hydrophobic layer. The first layer 104 included a mixture of metal oxide nanoparticles and a binder 103 that were coated on the core 102. The metal oxide nanoparticles included SiO₂, TiO₂, or Fe₂O₃. The binder 103 was selected from polyvinylidene chloride (PVDC), 3-Aminopropyl triethoxysilane (APTES), or polyvinylidene fluoride (PVDF) to facilitate a strong interfacial adhesion between the core 102 and the metal oxide nanoparticles, promoting a uniform coating. In some implementations, the binder 103 was directly coated on the core 102 before coating the first layer 104 of metal oxide nanoparticles.

The second layer 106 was deposited on top of the first layer 104. The second layer 106 included a metal oxide nanoparticle, selected from one of SiO₂, TiO₂, or Fe₂O₃. The metal oxide nanoparticle selected for the second layer 106 differed from that used in the first layer 104 in this case. The third layer 108 was deposited on top of the second layer 106. The third layer 108 included a metal oxide nanoparticle selected from one of SiO₂, TiO₂, or Fe₂O₃, differing from the metal oxide nanoparticles used in both the first and second layers in this example. A binder was not used in the second layer 106 and the third layer 108.

The factors that were considered to select SiO₂, TiO₂, or Fe₂O₃ as coating materials included the synthesis method, effective surface area, high surface absorption, and particle size. These nanoparticles range in size between 10-200 nanometers (nm) and offer effective surface areas per unit of mass, leading to improved surface adhesion and reduced interfacial tension (IFT). These nanoparticles are available at an industrial scale, making them more cost-effective than those synthesized at the laboratory scale.

To evaluate the various formulations for the MSC composite preparation, several factors were modified, such as the ball mill time. Each layer was deposited using the ball mill machine 202 for about 5 minutes. In some implementations, the ball mill machine was used to deposit a layer for a time period of about 15 minutes. The time was selected based on the desired coating thickness. The composition of the layers was also tested with a solvent, such as N-methylpyrrolidone (NMP). There was no noticeable impact on the coating thickness, indicating that NMP did not alter the performance or integrity of the coatings. Table 1 shows the formulations of the MSC composite. In some implementations, the core 102 was surrounded by a single layer of coated material or two layers of coated materials.

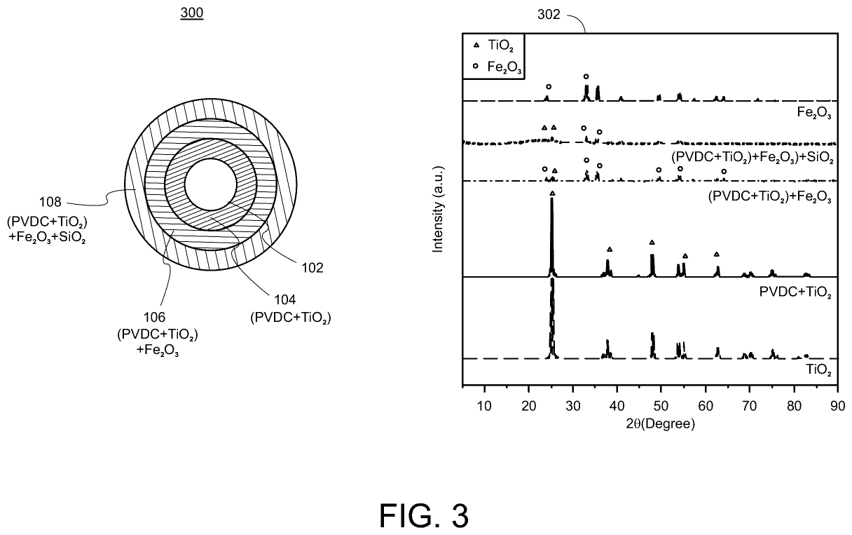

FIGS. 3, 4, and 5 show the X-ray diffraction (XRD) patterns for the MSC composite prepared using the various formulations shown in Table 1. XRD analysis is a non-destructive technique that analyzes the structure, composition, and properties of materials. The material is exposed to X-rays and the X-rays are scattered. The scattering angles and their intensities are measured. The XRD analysis is conducted to study the interfacial interaction of the different layers. The measured pattern is compared with entries in reference databases to confirm peak position and phase identification.

TABLE 1
Formulations used to coat the core using the ball milling method

| Formulation | 1 | 2 | 3 | 4 | 5 | 6 | 7 | 8 | 9 |
|---|---|---|---|---|---|---|---|---|---|
| APTES | One | One | One | — | — | — | — | — | — |
| | drop | drop | drop | | | | | | |
| PVDC (mg) | — | — | — | 11 | 11 | 11 | 11 | 11 | 11 |
| TiO₂ (mg) | 100 | 100 | 100 | 100 | 100 | — | 100 | 100 | 100 |
| Fe₂O₃ (mg) | — | 100 | 100 | — | 100 | 100 | 100 | 100 | 100 |
| SiO₂ (mg) | — | — | 100 | — | — | — | — | 100 | 100 |
| Ball mill | 5 | 5 | 5 | 5 | 5 | 5 | 5 | 5 | 5 |
| time (min) | | | | | | | | | |

FIG. 3 shows the XRD pattern for a MSC composite 300. The MSC composite 300 included an aluminum core 102, a first layer 104 that included a mixture of TiO₂ and the binder PVDC, a second layer 106 which included Fe₂O₃, and a third layer 108 which included SiO₂. This composition follows the formulation 8 in Table 1. The label ((PVDC+TiO₂)+Fe₂O₃)+SiO₂ in FIG. 3 should be read as the first layer 104 includes PVDC and TiO₂, the second layer 106 includes Fe₂O₃, and the third layer 108 includes SiO₂.

The XRD pattern 302 confirmed the formation of the MSC composite 300 by comparing the measured diffraction patterns with reference databases to identify the crystalline phases. The presence of TiO₂ and Fe₂O₃ was verified, with no significant peak shifts, indicating that the materials retained their original crystallinity throughout the layering process. Additionally, as each successive layer was deposited, the intensity of the diffraction peaks corresponding to the underlying layers decreased. This attenuation is attributed to the physical interaction and shielding effect, where the outer layers absorb or scatter incident X-rays, reducing the visibility of peaks from the inner layers. This effect was particularly evident in the progressive reduction of TiO₂ peak intensity as Fe₂O₃ and SiO₂ layers were added, confirming the sequential deposition of layers.

The physical interaction between layers involves surface adhesion and possible weak interfacial bonding, which led to slight changes in peak intensity without significant shifts in peak positions, indicating that no major new crystalline phases were formed. The shielding effect can influence the performance of multi-core composites by enhancing their stability and functionality. The PVDC+TiO₂ signal closely followed the pattern of pure TiO₂ but at a slightly higher intensity, suggesting that PVDC did not introduce new diffraction peaks but rather enhanced the TiO₂ signal due to improved dispersion or alignment.

The surface morphology of the MSC composite 300 was analyzed using a scanning electron microscope (SEM). The coated balls were scratched on the top surface mechanically using a focused ion beam to visualize the inside layers. The images showed that the coated materials were compact and had no porosity. This confirmed the integrity of the MSC composite material.

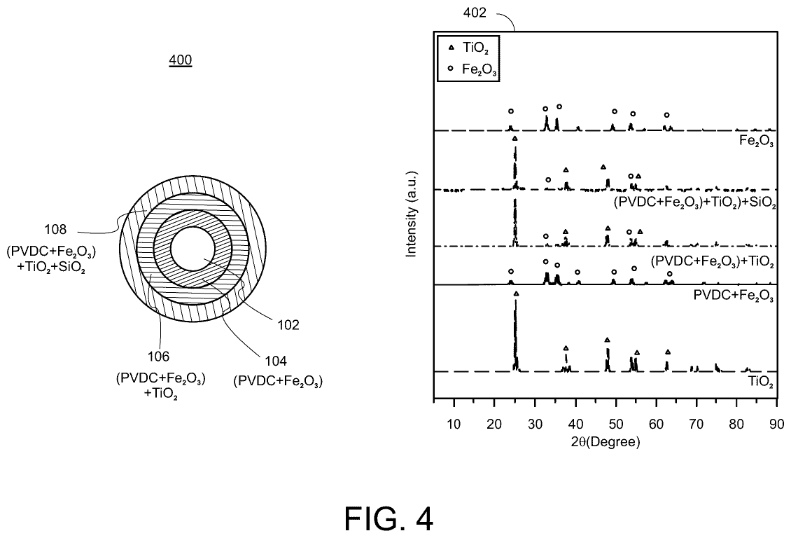

FIG. 4 shows the XRD patterns for a MSC composite 400. The MSC composite 400 included an aluminum core 102, a first layer 104 which included a mixture of Fe₂O₃ and the binder PVDC, a second layer 106 which included TiO₂, and a third layer 108 which included SiO₂. This composition follows the formulation 9 in Table 1.

The measured XRD pattern 402 was compared with entries in reference databases to confirm peak position and phase identification. The phase identification through XRD confirmed the successful coating of the MSC composite layers, with the peaks corresponding to specific inorganic metal oxide nanoparticles such as SiO2, TiO2, or Fe₂O₃, as identified in reference databases. The significance of this phase identification is its ability to verify the desired chemical composition and crystal structure of the materials used in the layers, which in turn determines that the dissolution and mechanical properties are consistent with the expected performance in the ICD. The XRD pattern 402 showed that as the layers were built, the intensity of peaks of the previously coated layers decreased due to the physical interaction and shielding effect.

The XRD results showed that the coatings were successfully integrated. The XRD pattern 402 revealed how these compositions affect dissolution, mechanical strength, and fluid flow regulation. These interactions, such as physical shielding or chemical bonding between layers, are used to predict the behavior of the MSC composite to determine its performance over the well's lifecycle.

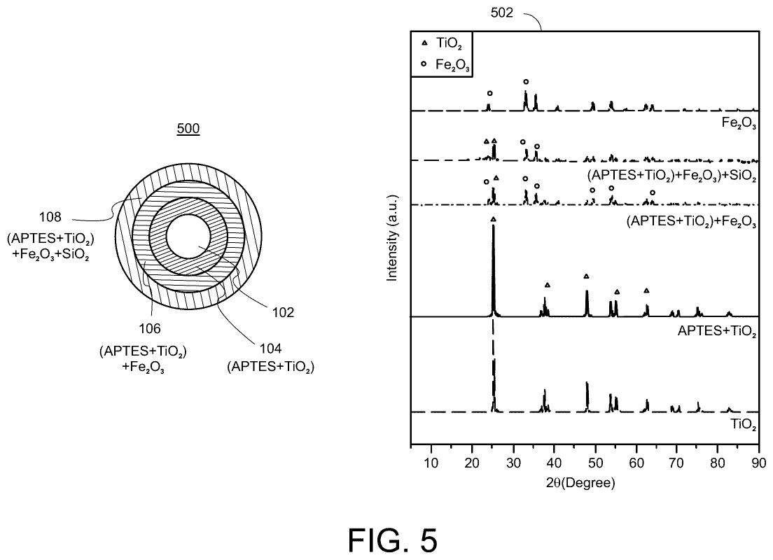

FIG. 5 shows XRD patterns for a MSC composite 500. The MSC composite 500 included an aluminum core 102, a first layer 104 which included a mixture of TiO₂ and the binder APTES, a second layer 106 which included Fe₂O₃, and a third layer 108 which included SiO₂. This composition follows the formulation 3 in Table 1.

The measured XRD pattern 502 was compared with entries in reference databases to confirm peak position and phase identification. Similar to the XRD patterns in FIGS. 3 and 4, the XRD pattern 502 showed that as the layers were built, the intensity of peaks of the previously coated layers decreased due to the physical interaction and shielding effect.

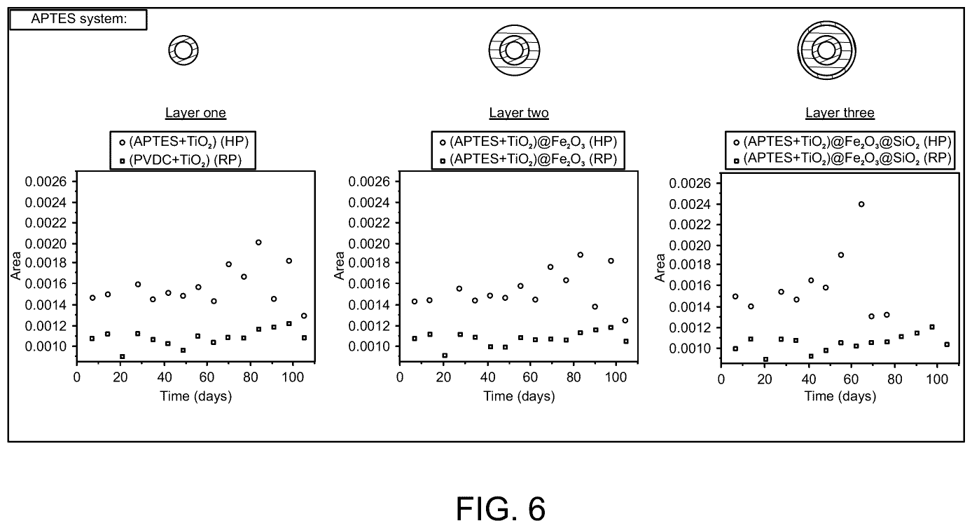

FIGS. 6, 7, and 8 show the experimental dissolution results for the different MSC composites. To get insights into the dissolution behavior and stability of the multi-layers, a systematic analysis using cyclic voltammetry (CV) was conducted at 80° C., under room and downhole pressure in seawater. The temperature was maintained using a thermostatic bath to simulate the conditions found in actual reservoir environments. The multi-shell composite ball samples were prepared and immersed in the seawater solution for testing with continuous stirring. In the CV analysis, the multi-shell coated layers underwent electrochemical testing, and the dissolution behavior was observed through changes in current density. By monitoring these changes, the rate of dissolution of the layers was assessed and correlated with their specific characteristics, such as thickness and material composition. This experimental approach allowed for the evaluation of the MSC composite's performance in terms of dissolution rate and stability.

The dissolution behavior of the multi-shell coated layers was inferred from changes in the integrated area under the CV curves. The area under the peaks of the CV curves were integrated to quantify the amount of dissolved material. The integrated area was used to correlate the thickness and composition of the coated layers. Specifically, slow changes in current density indicate a slow dissolution rate of the coating materials.

FIG. 6 is a plot presenting experimental dissolution results of a MSC composite 500 (composite shown in FIG. 5) that included APTES binder and TiO₂ in the first layer. The second layer included Fe₂O₃. The third layer included SiO₂.

FIG. 6 showed a gradual increase in the integrated area over successive cycles for all the coated layers, indicating a controlled and slow dissolution rate, rather than rapid degradation. Under downhole pressure conditions (about 47.4 kPa) an increased dissolution rate was observed (higher magnitude of area) compared to ambient pressure, which was due to the influence of pressure on this process. Overall, the slow dissolution indicated that the coating layers exhibited good stability and maintained their integrity over time, making them suitable for ICD applications that require sustained release or prolonged protection in harsh environments.

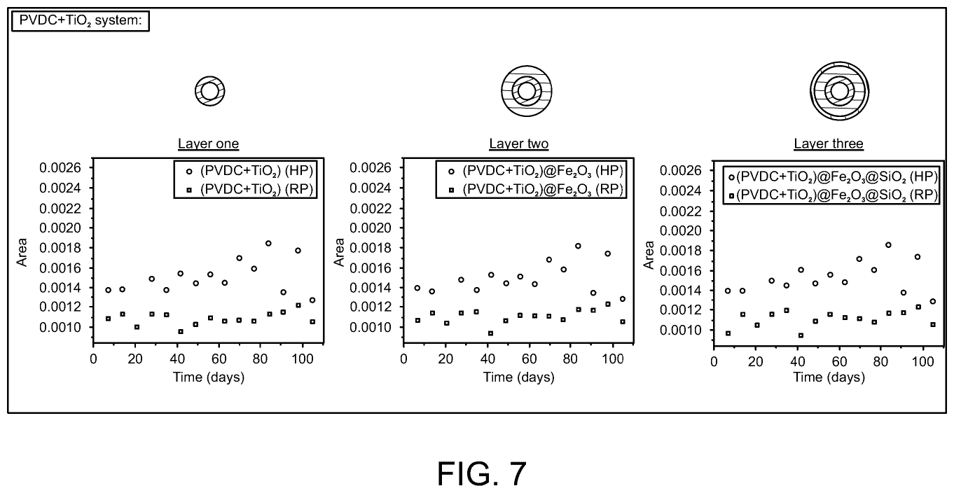

FIG. 7 is a plot presenting experimental dissolution results of a MSC composite 300 (composite shown in FIG. 3) that included PVDC binder and TiO₂ in the first layer. The second layer included Fe₂O₃. The third layer included SiO₂. A systematic analysis using cyclic voltammetry (CV) was conducted at 80° C., under room and downhole pressure in seawater.

Similar to the results disclosed in FIG. 6, the integrated areas under the CV curves for the MSC composite 300 also showed a gradual increase over successive cycles for all the layers, indicating a controlled and slow dissolution rate rather than rapid degradation. The dissolution rate increased under downhole pressure conditions (about 47.4 kPa) compared to the ambient pressure conditions.

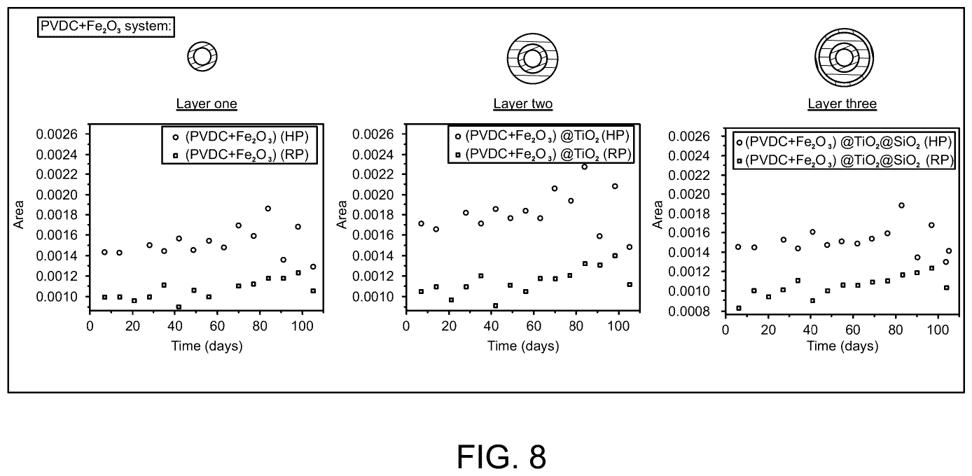

FIG. 8 is a plot presenting experimental dissolution results of a MSC composite 400 (composite shown in FIG. 4) that included PVDC binder and Fe₂O₃ in the first layer. The second layer included TiO₂. The third layer included SiO₂. A systematic analysis using CV was conducted at 80° C., under room pressure and downhole pressure in seawater.

Similar to the results shown in FIGS. 6 and 7, the integrated areas under the CV curves for the MSC composite 400 showed a gradual increase over successive cycles for all the coated layers, indicating a controlled and slow dissolution rate, rather than rapid degradation. The dissolution rate was higher under downhole pressure conditions (about 47.4 kPa) compared to the ambient pressure conditions.

Following the dissolution experiments, it was determined that a specific composite configuration was suitable for ICD applications. The design of the MSC composite was refined to comprise three layers: SiO₂ as the inner layer along with a binder (first layer), TiO₂ as the intermediate layer (second layer), and Fe₂O₃ as the outermost layer (third layer). This modification was guided by the contact angle results and other characterizations.

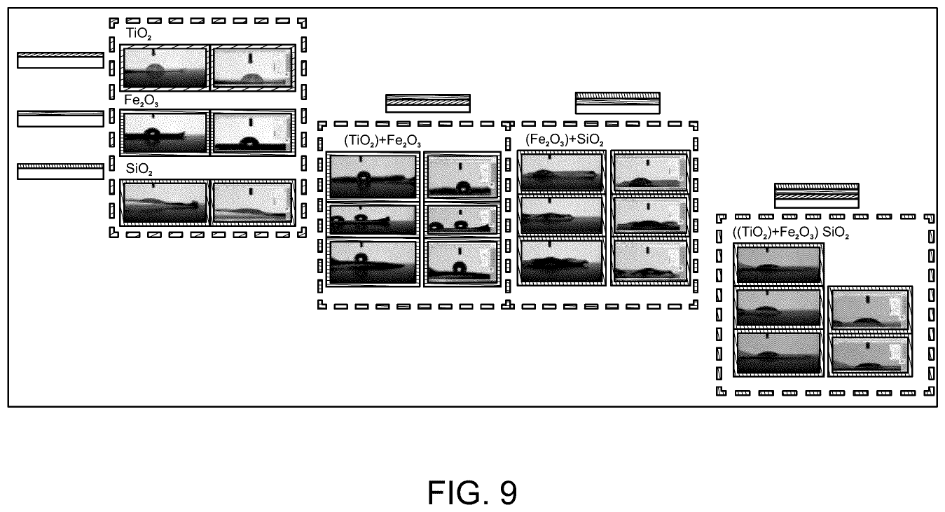

FIG. 9 shows contact angles of coated flat substrates. Contact angle measurements were used to determine the wettability of the layers on the MSC composite. The results of the contact angle measurements help in deciding how the MSC composite should be prepared based on the wetting properties of each layer and their interaction with the reservoir fluids. A contact angle less than 90 degrees indicates that the surface is hydrophilic with the degree of hydrophilicity corresponding to magnitude of the difference between the contact angle and 90 degrees. A contact angle greater than 90 degrees indicates that the surface is hydrophobic with the degree of hydrophobicity corresponding to magnitude of the difference between the contact angle and 90.

To study the hydrophobic and aqueous behavior of the layers of the MSC composite, contact angle measurements were made. In this case, a flat aluminum substrate was chosen for the purpose of making contact angle measurements. The aluminum foil was first cleaned and then coated with a PVDF binder with a coating ratio of 90:10 (metal oxide material: binder). Following this, a metal oxide was deposited on the aluminum substrate using a doctor blade and spread evenly across the substrate. Each layer was dried in a vacuum oven before depositing the next layer. The thickness of each layer was controlled by applying multiple coats after the previous layer had solidified. In some experiments only one metal oxide nanoparticle layer was deposited. In some experiments, two or three layers were deposited. The contact angle measurements were made at room temperature.

The measured contact angle values were: TiO₂—=85.1°, Fe₂O₃—=128.0°, SiO₂=30.8°, TiO₂+Fe₂O₃=88.2°, Fe₂O₃+SiO₂=59.9°, (TiO₂+Fe₂O₃)+SiO₂=40.8°. As shown in FIG. 9, the contact angle results demonstrated distinct wettability characteristics among the tested materials. TiO₂ and SiO₂ exhibited hydrophilic behavior, with contact angles of 85.1° and 30.8°, respectively. In contrast, Fe₂O₃ was hydrophobic, with a contact angle of 128.0°.

The contact angles of composite materials fall between these values, with TiO₂—Fe₂O₃ at 88.2°, Fe₂O₃—SiO₂ at 59.9°, and TiO₂—Fe₂O₃—SiO₂ at 40.8°, reflecting the combined effects of their individual components. These results provided insights into the surface interactions and potential applications of these materials in fluid environments. The multishell core composite was modified to have SiO₂ as the inner layer (first layer), TiO₂ as the intermediate layer (second layer), and Fe₂O₃ as the outermost layer (third layer) based on the contact angle results.

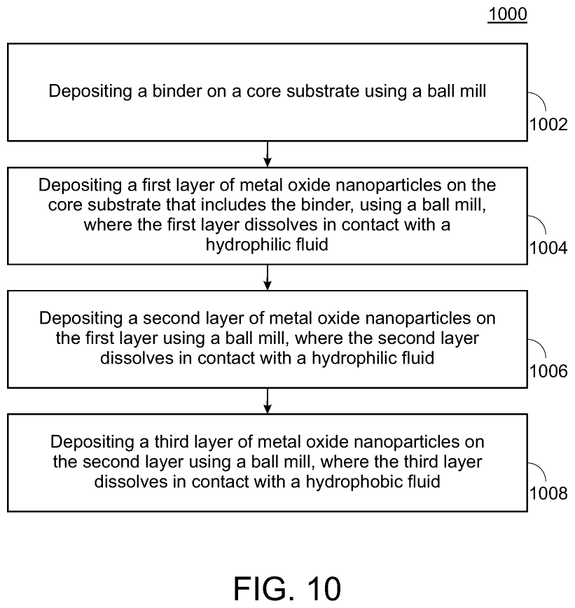

FIG. 10 is a process flow diagram for the preparation of the MSC composite. At block 1002, a binder is deposited on a core using a ball mill. The core does not dissolve in contact with hydrophobic and aqueous fluids. The core can include materials such as metallic or non-metallic ceramic, teflon, stainless steel, aluminum, glass, 13 chromium steel, alloy steel, or tungsten carbide. The binder can include PVDC, APTES, or PVDF. The role of the binder is to provide adhesion to the core and the subsequent layers to promote a uniform coating. This robust adhesion promotes the stability and durability of the coating, as it facilitates even dispersion of the coating materials during the ball milling process, preventing agglomeration.

At block 1004, a first layer of coating which includes a metal oxide nanoparticle is deposited on the surface of the core. The metal oxide nanoparticles include one of SiO2, TiO2, or Fe₂O₃. A ball mill machine is used to deposit the first layer. In some implementations, a mixture of the metal oxide nanoparticles and the binder are deposited on the core.

The first layer is a hydrophilic layer and selectively dissolves when in contact with a aqueous fluid, such as water produced during oil production. The dissolution rate of the first layer aligns with the onset of excessive water ingress during oil production. As water breakthrough occurs, water production increases steadily, eventually accounting for more than 70% of the total fluid volume. The composition of the first layer has a dissolution rate that aligns with the operational timeline of this increased water production. The dissolution rate for the first layer is about 45-55 days. After the dissolution of the first layer, the core is exposed. The core does not dissolve in contact with either hydrophobic or aqueous fluid.

At block 1006, a second layer that includes one of SiO2, TiO2, or Fe₂O₃ metal oxide nanoparticles is deposited on top of the first layer, using a ball mill machine. The metal oxide nanoparticle in the second layer can differ from the metal oxide nanoparticle in the first layer. The second layer is a hydrophilic layer and selectively dissolves when in contact with a aqueous fluid, such as water. The dissolution rate of the second layer aligns with the operational timeline of water breakthrough during oil production. Once water breakthrough occurs, it steadily increases, accounting for about 30-70% of the total fluid volume during production. The second layer dissolves when in contact with water after water breakthrough, continuing until the second layer dissolves. After dissolution of the second layer, the layer beneath it is exposed. The complete dissolution of the second layer takes about 100 days.

At block 1008, a third layer that includes one of SiO2, TiO2, or Fe₂O₃ metal oxide nanoparticles is deposited on top of the second layer, using a ball mill machine. The metal oxide nanoparticle in the third layer can differ from the metal oxide nanoparticles used in the first and second layers. The third layer is hydrophobic and selectively dissolves when in contact with a hydrophobic fluid, such as oil. The dissolution rate of the third and outermost layer aligns with the operational timeline of oil breakthrough and continues until the oil production accounts for about 60-70% of the total fluid volume. After complete dissolution of the third and outermost layer, the layer beneath it is exposed. The complete dissolution of the third layer takes about 7 days.

The MSC composite can switch its wettability through the dissolution of one layer, which exposes the layer beneath it to the reservoir fluids. The outermost layer dissolves when in contact with a hydrophobic fluid such as oil. The middle layer dissolves when in contact with a aqueous fluid, such as water. After complete dissolution of the middle layer, the inner layer is in contact with the reservoir fluids. The inner layer dissolves when in contact with a aqueous fluid, such as water, exposing the core beneath it. The MSC composite reduces in overall diameter as the coated layers dissolve and moves through the ICD. The core has a diameter that is lesser than the diameter of the outflow port of an ICD. Eventually, the core restricts the excess water production by blocking flow through the outflow port in the ICD.

### EXAMPLES

Certain aspects of the subject matter described here can be implemented as a composition for a multishell core composite. The multishell core composite includes a core. A first layer includes a first metal oxide nanoparticle and is coated on the core. The first layer is dissolvable when in contact with a aqueous fluid. The second layer includes a second metal oxide nanoparticle and is coated on the first layer. The second layer is dissolvable when in contact with a aqueous fluid. The third layer includes a third metal oxide nanoparticle. The third layer is dissolvable when in contact with a hydrophobic fluid.

An aspect combinable with any other aspect includes the following features. The first layer includes a mixture of a binder and the first metal oxide nanoparticle.

An aspect combinable with any other aspect includes the following features. The binder includes polyvinylidene chloride (PVDC), 3-Aminopropyl triethoxysilane (APTES), or polyvinylidene fluoride (PVDF).

An aspect combinable with any other aspect includes the following features. Each of the first layer, the second layer, and the third layer has a dissolution rate based on a lifecycle of an oil production well.

An aspect combinable with any other aspect includes the following features. The third layer dissolves when in contact with oil. The second layer dissolves when in contact with water and the first layer dissolves when in contact with water.

An aspect combinable with any other aspect includes the following features. The core includes metallic or non-metallic ceramic, teflon, stainless steel, aluminum, glass, 13 chromium steel, alloy steel, or tungsten carbide.

An aspect combinable with any other aspect includes the following features. The core is not dissolvable.

Certain aspects of the subject matter described here can be implemented as a method of forming a multishell core composite. The method includes coating a thin layer of binder on a core, using a ball mill. The method includes coating a first layer of a first metal oxide nanoparticle on the core by a ball mill. The first layer is dissolvable in contact with a aqueous fluid. The method includes coating a second layer of a second metal oxide nanoparticle on the first layer by a ball mill. The second layer is dissolvable in contact with a aqueous fluid. The method includes coating a third layer of a third metal oxide nanoparticle on the second layer by a ball mill. The third layer is dissolvable in contact with a hydrophobic fluid.

An aspect combinable with any other aspect includes the following features. Each of the first metal oxide nanoparticle, the second metal oxide nanoparticle, and the third metal oxide nanoparticle includes titanium oxide, silicon dioxide, or iron oxide.

An aspect combinable with any other aspect includes the following features. The dissolution rate of each of the first layer, the second layer, and the third layer depends on temperature, pH, pressure, salinity, and a contact fluid composition.

An aspect combinable with any other aspect includes the following features. The dissolution of the first layer occurs in a time period of 45-55 days when in contact with water.

An aspect combinable with any other aspect includes the following features. The dissolution of the second layer occurs in a time period of 90-100 days when in contact with water.

An aspect combinable with any other aspect includes the following features. The dissolution of the third layer occurs in a time period of 5-7 days when in contact with oil.

An aspect combinable with any other aspect includes the following features. Each of the first layer, the second layer, and the third layer is coated by the ball mill in a time period of 5-25 minutes.

An aspect combinable with any other aspect includes the following features. Each of the first layer, the second layer, and the third layer is about 1 mm in thickness.

Certain aspects of the subject matter described here can be implemented in an ICD of a production well. The ICD includes multiple inflow ports through which reservoir fluids flow into the ICD, a multishell core composite, and an outflow port though which reservoir fluids flow out of the ICD. The multishell core composite includes a core, a first layer of binder and first metal oxide coated on the core. The first layer is dissolvable when in contact with a aqueous fluid. The multishell core composite includes a second layer of a second metal oxide coated on the first layer. The second layer is dissolvable when in contact with a aqueous fluid. The multishell core composite includes a third layer of a third metal oxide coated on the second layer. The third layer is dissolvable when in contact with a hydrophobic fluid.

An aspect combinable with any other aspect includes the following features. Each of the first metal oxide, the second metal oxide, and the third metal oxide includes silicon dioxide, titanium dioxide, iron oxide, or a combination of them.

An aspect combinable with any other aspect includes the following features. Each of the first layer, the second later, and the third layer includes a uniform coating of 1 mm deposited by a ball mill.

An aspect combinable with any other aspect includes the following features. The binder includes polyvinylidene chloride (PVDC), 3-Aminopropyl triethoxysilane (APTES), polyvinylidene fluoride (PVDF), or mixtures of them.

Other implementations are also within the scope of the following claims.

What is claimed is:

1. A multi-shell core (MSC) composite comprising:
a core,
a first layer comprising a first metal oxide nanoparticle, the first layer coated on the core and dissolvable in contact with a aqueous fluid;
a second layer comprising a second metal oxide nanoparticle, the second layer coated on the first layer and dissolvable in contact with a aqueous fluid; and
a third layer comprising a third metal oxide nanoparticle, the third layer coated on the second layer, the third layer dissolvable in contact with a hydrophobic fluid.

2. The MSC composite of claim 1, wherein the first metal oxide nanoparticle comprises silicon dioxide, the second metal oxide nanoparticle comprises titanium oxide, and the third metal oxide nanoparticle comprises iron oxide.

3. The MSC composite of claim 1, wherein the first layer comprises a mixture of a binder and the first metal oxide nanoparticle.

4. The MSC composite of claim 3, wherein the binder comprises polyvinylidene chloride (PVDC), 3-Aminopropyl triethoxysilane (APTES), or polyvinylidene fluoride (PVDF).

5. The MSC composite of claim 1, wherein each of the first layer, the second layer, and the third layer has a dissolution rate based on a lifecycle of an oil production well.

6. The MSC composite of claim 5, wherein:
the third layer dissolves when in contact with oil;
the second layer dissolves when in contact with water; and
the first layer dissolves when in contact with water.

7. The MSC composite of claim 1, wherein the core comprises metallic or non-metallic ceramic, teflon, stainless steel, aluminum, glass, 13 chromium steel, alloy steel, or tungsten carbide.

8. The MSC composite of claim 7, wherein the core is not dissolvable.

9. A method of forming a multishell core composite, the method comprising:
coating by a ball mill, a core with a thin layer of a binder;
coating by a ball mill, a first layer on the core comprising the binder, the first layer comprising a first metal oxide nanoparticle, the first layer is dissolvable in contact with a aqueous fluid;
coating by a ball mill, a second layer on top of the first layer, the second layer comprising a second metal oxide nanoparticle, the second layer is dissolvable in contact with a aqueous fluid; and
coating by a ball mill, a third layer on top of the second layer, the third layer comprising a third metal oxide nanoparticle, the third layer is dissolvable in contact with a hydrophobic fluid.

10. The method of claim 9, wherein each of the first metal oxide nanoparticle, the second metal oxide nanoparticle, and the third metal oxide nanoparticle comprises titanium oxide, silicon dioxide, or iron oxide.

11. The method of claim 9, wherein dissolution rate of each of the first layer, the second layer, and the third layer depends on temperature, pH, pressure, salinity, and a contact fluid composition.

12. The method of claim 9, wherein coating each of the first layer, the second layer, and the third layer by the ball mill occurs in a time period of 5-25 minutes.

13. The method of claim 9, wherein each of the first layer, the second layer, and the third layer is about 1 mm in thickness.

14. A inflow control device (ICD) of a production well comprising:
a plurality of inflow ports through which a reservoir fluid flows into the ICD;
a multi-shell core composite placed in the ICD, the multi-shell core composite comprising:
a core;
a first layer, comprising a mixture of a binder and a first metal oxide, which is dissolvable in contact with a aqueous fluid, the first layer coated on the core;
a second layer, comprising a second metal oxide, which is dissolvable in contact with a aqueous fluid, the second layer coated on the first layer; and
a third layer, comprising a third metal oxide, which is dissolvable in contact with a hydrophobic fluid, the third layer coated on the second layer; and
an outflow port through which the reservoir fluid flows out of the ICD into the production well.

15. The ICD of claim 14, wherein each of the first metal oxide, the second metal oxide, and the third metal oxide comprises silicon dioxide, titanium dioxide, iron oxide, or mixtures thereof.

16. The ICD of claim 14, wherein each of the first layer, the second later, and the third layer comprises a uniform coating of 1 mm deposited by a ball mill.

17. The ICD of claim 14, wherein the binder comprises polyvinylidene chloride (PVDC), 3-Aminopropyl triethoxysilane (APTES), polyvinylidene fluoride (PVDF), or mixtures thereof.
